(19) United States
(12) Patent Application Publication
(10) Pub. No.: US 2019/0335814 A1
(43) Pub. Date: Nov. 7, 2019

(54) CIGARETTE CARTRIDGE, ATOMIZER AND ELECTRONIC CIGARETTE THEREOF

(71) Applicant: Changzhou Patent Electronic Technology Co., LTD, Changzhou (CN)

(72) Inventor: Weihua QIU, Changzhou (CN)

(21) Appl. No.: 16/512,217

(22) Filed: Jul. 15, 2019

Related U.S. Application Data
(63) Continuation-in-part of application No. PCT/CN2017/095286, filed on Jul. 31, 2017.

(30) Foreign Application Priority Data
Jan. 19, 2017 (CN) 201710037941.6

(51) Int. Cl. A24F 47/00; F16J 15/02

(52) U.S. Cl. CPC A24F 47/008; F16J 15/021

(57) ABSTRACT

A cigarette cartridge includes a liquid storage member, a liquid outlet mechanism provided on the liquid storage member, an elastic member accommodated in the liquid outlet mechanism, and a first magnetic member. The liquid storage member has a liquid storage chamber. The liquid outlet mechanism has a liquid guiding hole in communication with the liquid storage chamber. The cigarette cartridge also has a liquid outlet hole in communication with the liquid guiding hole. The first magnetic member is slidably accommodated within the liquid outlet mechanism. An end of the elastic member elastically abuts against the inner wall of the liquid outlet mechanism, and the other end of the elastic member elastically abuts against the first magnetic member. The first magnetic member is configured to close the liquid guiding hole under the action of the elastic member.

### CROSS-REFERENCE TO RELATED APPLICATIONS

The present application is a continuation-in-part of international application No. PCT/CN2017/095286 filed on Jul. 31, 2017, and claims priority to Chinese patent application No. 201710037941.6 filed on Jan. 19, 2017, and the entire disclosures of the foregoing applications are incorporated herein by reference.

### FIELD OF TECHNOLOGY

The invention relates to the technical field of smoke simulation, and more particularly, relates to a cigarette cartridge, an atomizer and an electronic cigarette having the atomizer.

### BACKGROUND

In a cigarette cartridge of conventional electronic cigarettes, the liquid storage chamber of the cigarette cartridge mainly defines an opening. Therefore, when the cigarette cartridge is disassembled, the tobacco liquid in the liquid storage chamber will leak out, not only a pollution is caused, but also the user's experience is influenced. Furthermore, when children disassemble the cigarette cartridge causally, a swallowing of the tobacco liquid by an accident occurs easily, a potential safety hazard exists.

### SUMMARY

Accordingly, it is necessary to provide a cigarette cartridge in with the tobacco liquid cannot leak out when the cigarette cartridge is separately stored. Further, an atomizer having the cigarette cartridge and an electronic cigarette having the atomizer are provided.

The technical solution provided in this disclosure to solve the problem is that: a cigarette cartridge provided by a first aspect of the disclosure, includes a liquid storage member defining a liquid storage chamber; a liquid outlet mechanism defining a liquid guiding hole in communication with the liquid storage chamber; an elastic member received in the liquid outlet mechanism; and a first magnetic member. Wherein the cigarette cartridge further defines a liquid outlet hole in communication with the liquid guiding hole, the first magnetic member is slidably accommodated within the liquid outlet mechanism; an end of the elastic member elastically resists an internal wall of the liquid outlet mechanism, an opposite end of the elastic member elastically resists the first magnetic member, the first magnetic member is capable of closing the liquid guiding hole under an action of the elastic member.

Further, the liquid outlet mechanism is received in the liquid storage member, the first magnetic member is slidable along an axial direction of the liquid storage member.

Further, the liquid guiding hole is defined on a sidewall of the liquid outlet mechanism, the liquid outlet hole is defined on a lower end of the liquid outlet mechanism.

Further, a lower end of the liquid storage member defines a through hole in communication with the liquid storage chamber, the lower end of the liquid outlet mechanism fixedly extends through the through hole.

Further, the liquid outlet mechanism is connected to the lower end of an outer of the liquid storage member, the first magnetic member is sliable along a radial direction of the liquid storage member.

Further, the liquid guiding hole is defined on a sidewall of the liquid outlet mechanism connected to the liquid storage member, the liquid outlet hole is defined on the liquid outlet mechanism and corresponds to the liquid guiding hole.

Further, the liquid storage member includes an internal sleeve and an external sleeve sleeved on the internal sleeve, the liquid storage chamber is formed by a cavity between the external sleeve and the internal sleeve, the liquid outlet mechanism is received in the liquid storage chamber and is sleeved on the internal sleeve, the elastic member and the first magnetic member are positioned in a cavity between the internal sleeve and the liquid outlet mechanism.

Further, the liquid outlet hole is defined on the internal sleeve, the liquid guiding hole is defined on a sidewall of the liquid outlet mechanism and corresponds to the liquid outlet hole

An atomizer provided by a second aspect of the disclosure, includes any one of the cigarette cartridge of the first aspect, wherein the atomizer further includes an atomizing assembly connected to the cigarette cartridge, the atomizing assembly includes a second magnetic member, the second magnetic member and the first magnetic member are mutually repulsive, when the atomizing assembly is assembled to the cigarette cartridge, a repulsive force between the second magnetic member and the first magnetic member is greater than an elastic force of the elastic member, the first magnetic member is capable of compressing and moving the elastic member, thereby opening the liquid guiding hole, allowing the liquid storage chamber to communicate with the liquid outlet hole.

Further, the atomizing assembly includes an atomizing end cover connected to the cigarette cartridge, an interior space of the atomizing end cover forms an atomizing chamber, the atomizing end cover defines a liquid intake hole corresponding to the liquid outlet hole and in communication with the atomizing chamber, the second magnetic member is fixedly accommodated in the atomizing chamber.

Further, the atomizing assembly includes an atomizing end cover connected to the cigarette cartridge, an interior space of the atomizing end cover forms an atomizing chamber, the atomizing end cover defines a liquid intake hole corresponding to the liquid outlet hole and in communication with the atomizing chamber, the second magnetic member is fixedly positioned on an upper end of the atomizing end cover.

Further, the atomizing assembly includes a connecting seat and an atomizing head, the connecting seat is connected to the cigarette cartridge, the atomizing head is fixedly positioned in the internal sleeve, the atomizing head defines an atomizing chamber, the atomizing head defines a permeable hole corresponding to the liquid outlet hole and in communication with the atomizing chamber, the second magnetic member is fixedly accommodated in the connecting seat.

An electronic cigarette provided by a third aspect of the disclosure, includes any one of the atomizer of the second aspect.

A cigarette cartridge is provided by a fourth aspect of the disclosure, the cigarette cartridge includes a liquid storage member defining a liquid storage chamber; an elastic member and a first magnet member both received in the liquid shortage member or positioned outside the liquid storage member; wherein the cigarette cartridge defines a liquid guiding hole in communication with the liquid storage chamber; an end of the elastic member is fixedly relative to the liquid storage member, an opposite end of the elastic member elastically resists the first magnetic member, the first magnetic member is capable of moving under an elastic action of the elastic member, causing the liquid guiding hole to be closed.

Further, the first magnetic member is slidable along an axial direction or along a radial direction of the liquid storage member.

Further, the cigarette cartridge further includes a sealing member fixedly connected to the first magnetic member, when the first magnetic member moves under an elastic force of the elastic member, the sealing member closes the liquid guiding hole.

Further, the cigarette cartridge further includes a liquid outlet mechanism, wherein the liquid guiding hole is positioned on the liquid outlet mechanism, the cigarette cartridge further defines a liquid outlet hole in communication with the liquid guiding hole, the first magnetic member is slidably accommodated within the liquid outlet mechanism, an end of the elastic member elastically resists an internal wall of the liquid outlet mechanism, an opposite end of the elastic member elastically resists the first magnetic member, the first magnetic member is capable of closing the liquid guiding hole under an action of the elastic member.

Further, the liquid guiding hole is defined on a sidewall of the liquid outlet mechanism, the liquid outlet hole is defined on a lower end of the liquid outlet mechanism.

Further, the liquid storage member includes an internal sleeve and an external sleeve sleeved on the internal sleeve, the liquid storage chamber is formed by a cavity between the external sleeve and the internal sleeve, the liquid outlet mechanism is received in the liquid storage chamber and is sleeved on the internal sleeve, both the elastic member and the first magnetic member are positioned in a cavity between the internal sleeve and the liquid outlet mechanism.

Further, the liquid outlet hole is defined on the internal sleeve, the liquid guiding hole is defined on a sidewall of the liquid outlet mechanism and corresponds to the liquid outlet hole.

Further, the elastic member is retractable along an axial direction of the liquid storage member, an end of the elastic member resists a top of the liquid outlet mechanism, an opposite end of the elastic member resists the first magnetic member, the external wall of the first magnetic member tightly contacts the internal wall of the liquid outlet mechanism, thereby closing the liquid guiding hole of the liquid outlet mechanism.

An atomizer, includes a cigarette cartridge and an atomizing assembly connected to the cigarette cartridge, the cigarette cartridge includes: a liquid storage member defining a liquid storage chamber; an elastic member and a first magnet member both received in the liquid shortage member or positioned outside the liquid storage member; wherein the cigarette cartridge defines a liquid guiding hole in communication with the liquid storage chamber; an end of the elastic member is fixedly relative to the liquid storage member, an opposite end of the elastic member elastically resists the first magnetic member, the first magnetic member is capable of moving under an elastic action of the elastic member, causing the liquid guiding hole to be closed, the atomizing assembly includes a second magnetic member, the second magnetic member and the first magnetic member are mutually repulsive, when the atomizing assembly is assembled to the cigarette cartridge, a repulsive force between the second magnetic member and the first magnetic member is greater than an elastic force of the elastic member, the first magnetic member is capable of compressing and moving the elastic member, causing the liquid guiding hole to be opened.

Further, the atomizing assembly includes an atomizing end cover connected to the cigarette cartridge, an interior space of the atomizing end cover forms an atomizing chamber, the atomizing end cover defines a liquid intake hole in communication with the atomizing chamber, the second magnetic member is fixedly accommodated in the atomizing chamber.

Further, the atomizing assembly includes a connecting seat and an atomizing head, the connecting seat is connected to the cigarette cartridge, the atomizing head is fixedly positioned in the internal sleeve, the atomizing head defines an atomizing chamber and a permeable hole in communication with the atomizing chamber, the second magnetic member is fixedly received in the connecting seat.

Further, a sidewall of the connecting seat defines a first air intake hole, an upper end surface of the connecting seat defines a second air intake hole in communication with the first air intake hole. Further, the atomizer further includes a heating structure received in the atomizing end cover, wherein the heating structure is fixedly positioned in the atomizing chamber.

Further, both the first magnetic member and the second magnetic member are electromagnets.

An electronic cigarette is provided by a sixth aspect of the disclosure. The electronic cigarette includes an atomizer; the atomizer includes a cigarette cartridge and an atomizing assembly connected to the cigarette cartridge; the cigarette cartridge includes: a liquid storage member defining a liquid storage chamber; an elastic member and a first magnet member both received in the liquid shortage member or positioned outside the liquid storage member; wherein the cigarette cartridge defines a liquid guiding hole in communication with the liquid storage chamber; an end of the elastic member is fixedly relative to the liquid storage member, an opposite end of the elastic member elastically resists the first magnetic member, the first magnetic member is capable of moving under an elastic action of the elastic member, causing the liquid guiding hole to be closed, the atomizing assembly includes a second magnetic member, the second magnetic member and the first magnetic member are mutually repulsive, when the atomizing assembly is assembled to the cigarette cartridge, a repulsive force between the second magnetic member and the first magnetic member is greater than an elastic force of the elastic member, the first magnetic member is capable of compressing and moving the elastic member, causing the liquid guiding hole to be opened.

Further, the electronic cigarette includes a battery pack connected to the atomizer, wherein the battery pack includes a battery housing, a battery and a power source switch, the battery is fixedly received in the battery housing, the battery is electrically connected to the heating member, the power source switch is positioned on the battery housing, and the power source switch is electrically connected to the battery.

Further, the liquid storage member is made of transparent materials of translucent materials. Further, the cigarette cartridge including a housing and the liquid storage member received in the housing, the housing defines an opening at a lower end, an upper end of the housing forms a mouth piece connector in communication with an interior chamber of the housing and extending upward along an axial direction of the housing, an exhaust passage is positioned between the liquid storage member and the housing, the exhaust passage is in communication with the mouth piece connector.

The advantages of the invention are described as follows: in the cigarette cartridge provided by the invention, when the cigarette cartridge is separately stored, because the first magnetic member is subjective to an elastic action of the elastic member and seals the liquid guiding hole, thus the liquid storage chamber is isolated from the liquid outlet hole. A leakage of the tobacco liquid and an accident swallowing of the tobacco liquid can be avoided. It plays a certain role in protecting children.

### BRIEF DESCRIPTION OF THE DRAWINGS

Exemplary embodiments of the invention are described more fully hereinafter with reference to the accompanying drawings.

FIG. 1 is a schematic view of an electronic cigarette according a first embodiment of the disclosure;

FIG. 2 is a schematic view of a cigarette cartridge of the electronic cigarette of FIG. 1;

FIG. 3 is a schematic view of an atomizing assembly connected to a battery pack in the electronic cigarette of FIG. 1;

FIG. 4 is a schematic view of an electronic cigarette of a second embodiment of the disclosure;

FIG. 5 is a schematic view of a cigarette cartridge of the electronic cigarette of FIG. 4;

FIG. 6 is a schematic view of an atomizing assembly connected to a battery pack in the electronic cigarette of FIG. 4;

FIG. 7 is a schematic view of an electronic cigarette of a third embodiment of the disclosure; and

FIG. 8 is a schematic view of a cigarette cartridge connected to the atomizing head in the electronic cigarette of FIG. 7.

Designations and reference numerals of the part and component in the accompanying drawings

| | | |
|---|---|---|
| electronic cigarette 100, 200, 300 | cigarette cartridge101 | atomizing assembly 102 |
| atomizer 10 | housing 11 | liquid storage member 12 |
| liquid outlet mechanism 13 | elastic member 14 | first magnetic member 15 |
| connecting seat 21 | atomizing end cover 22 | heating structure 23 |
| second magnetic member 24 | battery housing 31 | battery 32 |
| battery switch 33 | mouth piece connector 111 | liquid storage chamber 121 |
| air exhaust passage 122 | through hole 123 | liquid guiding hole 131 |
| first air intake hole 211 | second air intake hole 212 | smoke outlet hole 213 |
| atomizing chamber 221 | liquid intake hole 222 | battery pack 30 |
| liquid outlet hole 132 | air exhaust tube 16 | atomizing head 25 |
| internal sleeve 124 | external sleeve 125 | |

### DETAILED DESCRIPTION OF THE PREFERRED EMBODIMENT

The invention is specifically illustrated with reference to accompanying drawings. The accompanying drawings are schematic views which simplified shows fundamental structures of an exemplary embodiment of the invention. Thus, merely the constructions related to the invention are shown

### The First Embodiment

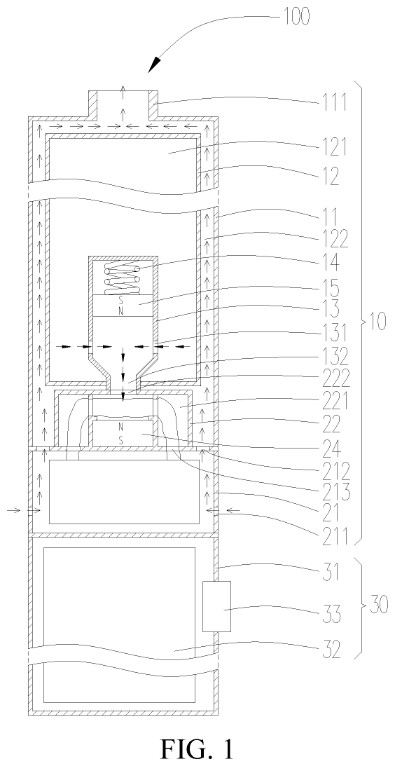

Referring to FIG. 1 through FIG. 3, an electronic cigarette 100 is provided by the first embodiment of the disclosure. The electronic cigarette 100 includes an atomizer 10 and a battery pack 30 connected to the atomizer 10. The atomizer 10 includes a cigarette cartridge 101 and an atomizing assembly 102 detachably positioned on a lower end of the cigarette cartridge 101. The battery pack 30 is fixed positioned on a lower end of the atomizing assembly 102. The atomizing assembly 102 is capable of absorbing the tobacco liquid in the cigarette cartridge 101, under the electric drive of the battery pack 30, the tobacco liquid is heated and atomized to form aerosol to be inhaled by a user.

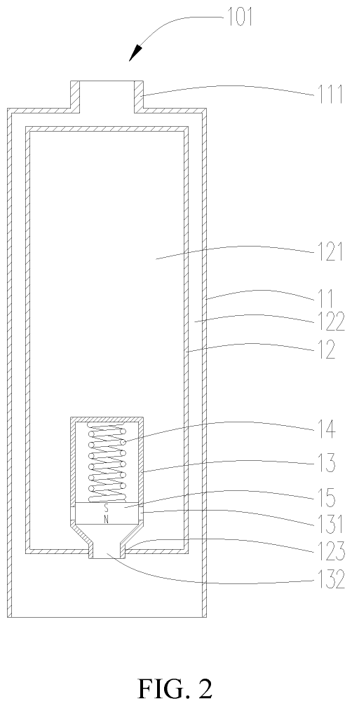

Specifically referring to FIG. 2, the cigarette cartridge 101 includes a housing 11, a liquid storage member 12 fixedly accommodated within the housing 11, a liquid outlet mechanism 13, an elastic member 14, and a first magnetic member 15. The liquid outlet mechanism 13, the elastic member 14, and the first magnetic member 15 are received in the liquid storage member 12. The elastic member 14 is positioned in the liquid outlet mechanism 13, the first magnetic member 15 is slidably accommodated in the liquid outlet mechanism 13.

The housing 11 substantially has a hollow cylindrical structure. The housing 11 has an opening at a lower end. The housing 11 forms a mouth piece connector 111 extending upward from the upper end of the housing 11 along an axial direction of the housing 11. The mouth piece connector 111 is in communication with the interior chamber of the housing 11. In the illustrated embodiment, when user inhales, the mouth piece connector 111 is held in user's mouth directly for inhaling the aerosol. It can be understood that, in alternative embodiment not shown, communication members (not shown) such as a mouth piece can also be connected to the mouth piece connector 111, user holds the communication member in mouth to conduct a wallowing of the aerosol.

The liquid storage member 12 substantially has a hollow tubular structure, the interior space of the liquid storage member 12 forms a liquid storage chamber 121 for storing the tobacco liquid. An air exhaust passage 122 is formed between the liquid storage member 12 and the housing 11, and is in communication with the mouth piece connector 111.

It can be understood that, the liquid storage member 12 is fixedly accommodated in the housing 11 by an interference fit. The external wall of the liquid storage member 12 defines at least one groove (not labeled) along an axial direction of the liquid storage member 12. At the time, the air exhaust passage 122 is thus formed by the space between the groove and the internal wall of the housing 11. Or, at least one fixing member (not shown) such as a connecting rod is positioned between the external wall of the liquid storage member 12 and the internal wall of the housing 11, an end of the fixing member is fixedly connected to the liquid storage member 12, an opposite end of the fixing member is fixedly connected to the housing 11, thereby allowing the liquid storage member 12 to be fixedly accommodated in the housing 11. At the time, the air exhaust passage 122 is thus formed by the space between the external wall of the liquid storage member 12 and the internal wall of the housing 11

Both the housing 11 and the liquid storage member 12 are made of transparent materials of translucent materials, facilitating for user to observe the residual amount of the tobacco liquid. In the illustrated embodiment, both the housing 11 and the liquid storage member 12 are made of glass material.

Further, the lower end of the liquid storage member 12 defines a though hole 123 in communication with the liquid storage chamber 121.

The liquid outlet mechanism 13 is accommodated in the liquid storage chamber 121, the liquid outlet mechanism 13 substantially has a hollow bottle-like structure. The lower end of the liquid outlet mechanism 13 defines a liquid outlet hole 132 in communication with the liquid outlet mechanism 13. The lower end of the liquid outlet mechanism 13 fixedly extends into the through hole 123 of the liquid storage member 12. The sidewall of the liquid outlet mechanism 13 defines at least one liquid guiding hole 131, the liquid guiding hole 131 is in communication with the liquid storage chamber 121 and the interior chamber of the liquid outlet mechanism 13 at the same time. In the illustrated embodiment, a number of the liquid guiding hole 131 is two, the two liquid guiding holes 131 are positioned on the liquid outlet mechanism 13 and are opposite to each other. It can be understood that, in alternative embodiment not shown, the number of the liquid guiding hole 131 can be one, three or more than three.

The elastic member 14 is retractable along the axial direction of the liquid storage member 12. An end of the elastic member 14 elastically resists a top of the liquid outlet mechanism 13, an opposite end of the elastic member 14 elastically resists the first magnetic member 15, the external wall of the first magnetic member 15 tightly contacts the internal wall of the liquid outlet mechanism 13, and is capable of closing the liquid guiding hole 131 of the liquid outlet mechanism 13. When the cigarette cartridge 101 is disassembled and stored separately, due to the elastic force of the elastic member 14, the first magnetic member 15 is moved downwardly, until the first magnetic member 15 closes the liquid guiding hole 131. At the time, the liquid storage chamber 121 is closed, the tobacco liquid in the liquid storage chamber 121 cannot flow into the liquid outlet mechanism 13 via the liquid guiding hole 131.

In an alternative embodiment, the liquid outlet mechanism 13 can be omitted, at the time, the liquid guiding hole 131 in communication with the liquid storage chamber 121 is positioned on the cigarette cartridge 101. For example, the liquid guiding hole 131 is positioned on the liquid storage member 12 or is positioned on the base seat of the lower end of liquid storage member 12, which is not specifically descried hereby. Further, at the time, both the elastic member 14 and the first magnetic member 15 are positioned in the liquid storage member 12, an end of the elastic member 14 resists the internal wall of the liquid storage member 12, an opposite end of the elastic member 14 elastically resists the first magnetic member 15, under the elastic force of the elastic member 14, the first magnetic member 15 can move to close the liquid guiding hole 131. In alternative embodiments, an end of the elastic member 14 not only can resist the internal wall of the liquid storage member 12, but also can resist other parts of the cigarette cartridge 101 such as a smoke outlet tube or a mouth piece, according to the structure of the cigarette cartridge 101, if only an end of the elastic member 14 is fixedly relative to the liquid storage member 12. It can be understood that, in alternative embodiment, the liquid outlet mechanism 13 can be omitted. Both the elastic member 14 and the first magnetic member 15 can be positioned outside the liquid storage member 12, an end of the external wall of the liquid storage member 12, an opposite end of the elastic member 14 elastically resists the first magnetic member 15, under the elastic force of the elastic member 14, the first magnetic member 15 can move to close the liquid guiding hole 131.

In a further alternative embodiment, the cigarette cartridge 101 further includes a sealing member (not shown) fixedly connected to the first magnetic member 15, when the first magnetic member 15 moves under the elastic action of the elastic member 14, the sealing member closes the liquid guiding hole 131. It can be understood that, the sealing member can be made of materials of silica gel or rubber, which is not specifically limited. The sealing member can be connected to the first magnetic member 15 by sleeving or adhering or pressing, which is not limited hereby. Compared to employing the first magnetic member only, by a configuration of the sealing member, a better sealing effect can be provided.

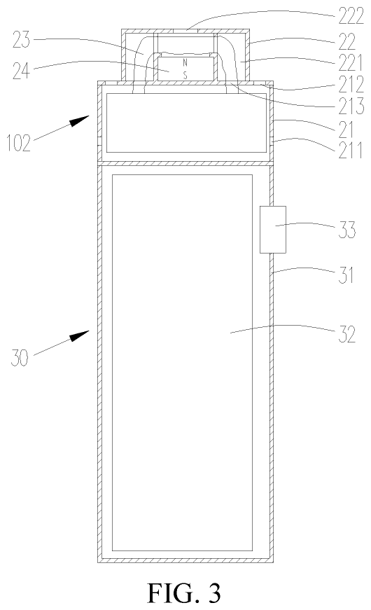

Specifically, referring to FIG. 3, the atomizing assembly 102 includes a connecting seat 21 detachably connected to the lower end of the housing 11, an atomizing end cover 22 positioned on an upper end of the connecting seat 21, a heating structure 23 and a second magnetic member 24. The heating structure 23 and the second magnetic member 24 are received in the atomizing end cover 22.

The connecting seat 21 substantially has a cylindrical structure, the upper end of the connecting seat 21 is detachably connected to the lower end of the housing 11. It can be understood that, by a configuration of threads, the connecting seat 21 can be connected to the housing 11 by a threaded connection. Or, by a configuration of lathing groove and latching tab, a latching connection is established between the connecting seat 21 and the housing 11. Or, connecting portions between the connecting seat 21 and the housing 11 are provided with magnetic materials, and then a magnetic connection is established between the connecting seat 21 and the housing 11. The detachable connection structure between the connecting seat 21 and the housing 11 are not limited hereby.

Further, the sidewall of the connecting seat 21 defines a first air intake hole 211, the upper end surface of the connecting seat 21 defines at least one second air intake hole 212 in communication with the first air intake hole 211 and the air exhaust passage 122 at the same time.

The atomizing end cover 22 substantially has a cylindrical structure, the interior space of the atomizing end cover 22 forms an atomizing chamber 221. Further, in order to facilitate for delivering the aerosol generated in the atomizing end cover 22 into user's mouth, the upper end surface of the connecting seat 21 defines at least one smoke outlet hole 213 corresponding to the atomizing chamber 221 and in communication with the atomizing chamber 221. It can be understood that, in alternative embodiment not shown, the smoke outlet hole 213 can also be positioned on the sidewall of the atomizing end cover 22. The smoke outlet hole 213 is in communication with the air exhaust passage 122, the target of delivering the aerosol into user's mouth can also be realized.

Further, the upper end surface of the atomizing end cover 22 defines a liquid intake hole 222 corresponding to the liquid outlet hole 132 of the liquid outlet mechanism 13 and in communication with the atomizing chamber 221.

The heating structure 23 is fixedly positioned in the atomizing chamber 221. The heating structure 23 includes a heating member (not labeled) and a liquid guiding member (labeled) which are wrapped around each other. The liquid guiding member is positioned correspondingly to the liquid intake hole 222 for absorbing the tobacco liquid. The heating member is electrically connected to the battery pack 30. It can be understood that, the liquid guiding member can be the member having a capacity of absorbing the tobacco liquid, such as a cotton or a porous ceramic and so on. The heating member can be the member such as a heating strip or a heating plate.

The second magnetic member 24 is fixedly positioned in the atomizing chamber 221, and the second magnetic member 24 and the first magnetic member 15 are mutually repulsive. Further, when the cigarette cartridge 101 is assembled to the atomizing assembly 102, the repulsive force between the second magnetic member 24 and the first magnetic member 15 can be greater than the elastic force of the elastic member 14, allowing the first magnetic member 15 to move upward.

In the illustrated embodiment, both the first magnetic member 15 and the second magnetic member 24 are bar-type magnets. The north poles N of the first magnetic member 15 and the second magnetic member 24 face each other, to establish a repulsive force. It can be understood that, the shape of the magnet can be cylindrical shape or other shape, if only the first magnetic member 15 and the second magnetic member 24 repel each other, which are not limited hereby. It can also be understood that, in alternative embodiment not shown, the south poles S of the first magnetic member 15 and the second magnetic member 24 face each other. It can also be understood that, the first magnetic member 15 and the second magnetic member 24 can also be electromagnets, a repulsive action between the first magnetic member 15 and the second magnetic member 24 is established by a control of the spiral orientation of the coil or the current flowing through the coil.

The battery pack 30 includes a battery housing 31, a battery 32 and a power source switch 33. The upper end of the battery housing 31 is fixedly connected to the lower end of the atomizing end cover 22. The battery 32 is fixedly accommodated in the battery housing 31, and the battery 32 is electrically connected to the heating member. The power source switch 33 is positioned on the battery housing 31, and the power source switch 33 is electrically connected to the battery 32, for controlling the power supplying situation of the battery 32 for the heating member.

The assembly and the usage of the electronic cigarette 100 of the disclosure is illustrated with the accompanying drawings as follows:

In the electronic cigarette 100 provided by the disclosure, when it leaves factory, the atomizing assembly 102 has already been fixedly connected to the battery pack 30, as shown in FIG. 3. When user wants to inhale, the cigarette cartridge 101 is merely required to be aligned to and assembled to the atomizing assembly 102.

Referring to FIG. 2, when the cigarette cartridge 101 is stored separately, due to an elastic force of the elastic member 14, the first magnetic member 15 is moved downward under the elastic action. When the first magnetic member 15 moves to resist the lower end of the liquid outlet mechanism 13, the liquid guiding hole 131 of the liquid outlet mechanism 13 is closed by the first magnetic member 15, thereby closing the liquid storage chamber 121, the liquid storage chamber 121 is isolated from the liquid outlet hole 132, the tobacco liquid cannot follow out.

Referring to FIG. 1, when the cigarette cartridge 101 is aligned to and assembled to the atomizing assembly 102, the atomizing assembly 102 approaches the cigarette cartridge 101 gradually, causing the second magnetic member 24 to approach the first magnetic member 15 gradually. When the repulsive force between the second magnetic member 24 and the first magnetic member 15 is greater than the elastic force of the first elastic member 14, the first magnetic member 15 is enabled to move upward. At the time, the liquid guiding hole 131 of the liquid outlet mechanism 13 is opened gradually, the liquid storage chamber 121 is opened to communicate with the liquid outlet mechanism 13. The tobacco liquid flows into the liquid outlet mechanism 13 via the liquid guiding hole 131, and then the tobacco liquid flows out the liquid outlet hole 132 and is absorbed by the liquid guiding member by passing through the liquid intake hole 222. The tobacco liquid is heated under the electric drive of the heating member and atomized to form aerosol, the aerosol fills the atomizing chamber 221. The indicated direction by the bold arrow in FIG. 1 is the flowing direction of the tobacco liquid.

When user inhales, the external air flows into the connecting seat 21 via the first air intake hole 211, the aerosol in the atomizing chamber 221 also flows into the connecting seat 21 via the smoke outlet hole 213, the air is mixed with the aerosol, and then the mixed aerosol enters into user's mouth by passing through the second air intake hole 212, the air exhaust passage 122 and the mouth piece connector 111 successively. The indicated direction of the fine arrow in FIG. 1 is the flowing direction of the air flow.

When the cigarette cartridge 101 is disassembled and separated from the atomizing assembly 102, the second magnetic member 24 moves away from the first magnetic member 15 gradually, the repulsive force between the second magnetic member 24 and the first magnetic member 15 decreases gradually and goes down to zero. At the time, due to an elastic force of the elastic member 14, the first magnetic member 15 is moved downward until the first magnetic member 15 closes the liquid guiding hole 131 again. The liquid storage chamber 121 is isolated from the liquid guiding hole 131 again, the tobacco liquid cannot flow out. At the time, the cigarette cartridge 101 is positioned at the state shown in the FIG. 2. Therefore, even if children opens the cigarette cartridge 101 causally, the leakage of the tobacco liquid cannot occur, an accident swallowing of the tobacco liquid by children is avoided, it plays a certain role in protecting children. Further, the liquid storage chamber 121 is closed by the first magnetic member 15, compared to the traditional structure, the first magnetic member 15 does not deteriorate, a service life is prolonged.

It can be understood that, in alternative embodiment not shown, a part of the liquid guiding member can further extend out of the atomizing end cover 22 by passing through the liquid intake hole 222. When the cigarette cartridge 101 is connected to the atomizing assembly 102, a part of the liquid guiding member extends into the liquid outlet mechanism 13, allowing the tobacco liquid to be absorbed by the liquid guiding member gradually, the redundant tobacco liquid is prevented from flowing into the atomizing assembly 102.

In still an alternative embodiment, the liquid outlet mechanism 13 is omitted, at the time, the tobacco liquid in the liquid storage chamber 121 flows into the atomizing chamber 221 directly by passing through the liquid guiding hole 131.

In the atomizer 10 of the first embodiment of the disclosure, according to the homogeneous repulsion principle of the magnetic pole, the movement of the first magnetic member 15 is controlled, thereby the liquid storage chamber 121 can be opened when the cigarette cartridge 101 is assembled, the liquid storage chamber 121 can be closed when the cigarette cartridge 101 is closed. When the cigarette cartridge 101 is stored separately, a leakage of the tobacco liquid and an accident swallowing of the tobacco liquid by children can be avoided.

In the electronic cigarette 100 provided by the first embodiment of the disclosure, because the electronic cigarette 100 includes all the technical features of aforementioned atomizer 10, thus the electronic cigarette 100 possesses all the technical effects same as that of aforementioned atomizer 10.

### The Second Embodiment

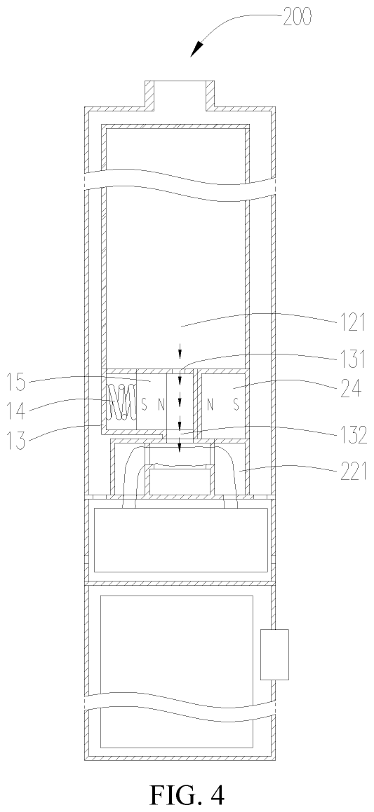

Referring to FIG. 4 through FIG. 6, the main difference between the electronic cigarette 200 provided by the second embodiment and the electronic cigarette 100 provided by the first embodiment is that, the liquid outlet mechanism 13 is positioned outside the liquid storage member 12, the second magnetic member 24 is positioned outside the atomizing end cover 22.

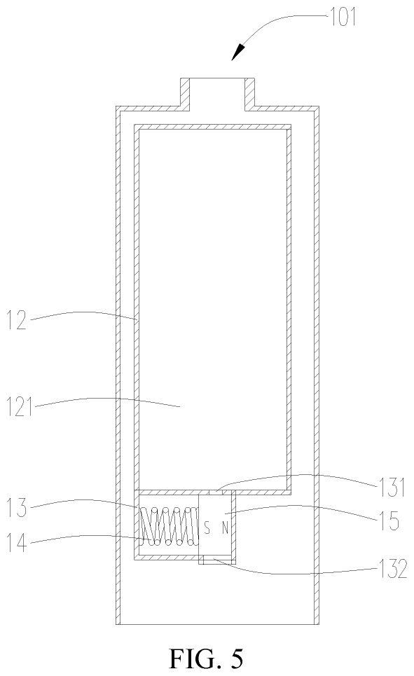

Specifically, referring to FIG. 5, the liquid outlet mechanism 13 is fixedly connected to the lower end surface of the liquid storage member 12, the liquid guiding hole 131 is defined on the surface connecting the liquid outlet mechanism 13 with the liquid storage member 12. The liquid outlet hole 132 is defined on the liquid outlet mechanism 13 and corresponds to the liquid guiding hole 131, the liquid outlet hole 132 is in communication with the liquid guiding hole 131. The elastic member 14 is retractable along the radial direction of the liquid storage member 12. An end of the elastic member 14 elastically resists the liquid outlet mechanism 13, an opposite end of the elastic member 14 elastically resists the first magnetic member 15. The first magnetic member 15 is slidably accommodated in the liquid outlet mechanism 13, and is slidable along a direction perpendicular to the axial direction of the liquid storage member 12. When the cigarette cartridge 101 is stored separately, due to an elastic action of the elastic member 14, the first magnetic member 15 is fixedly pressed, the first magnetic member 15 seals the liquid guiding hole 131 and the liquid outlet hole 132, the liquid storage chamber 121 is isolated from the liquid outlet hole 132, the tobacco liquid cannot flow out.

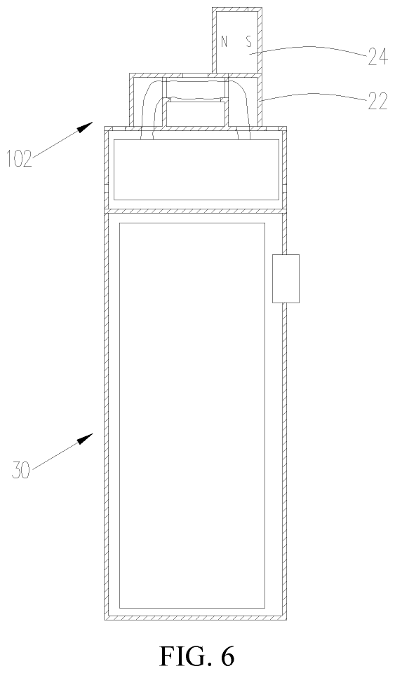

Referring to FIG. 6, the second magnetic member 24 is fixedly positioned on the upper end surface of the atomizing end cover 22. Referring to FIG. 4, when in a normal use, the cigarette cartridge 101 is connected to the atomizing assembly 102, the second magnetic member 24 is positioned on a side of the first magnetic member 15 opposite to the elastic member 14. The second magnetic member 24 and the first magnetic member 15 are mutually repulsive. The repulsive force between the second magnetic member 24 and the first magnetic member 15 is greater than the elastic force of the first elastic member 14, thus the first magnetic member 15 compresses the elastic member 14 and moves, and the liquid guiding hole 131 is opened finally. It should be noted that the liquid guiding hole 131 can be opened by the first magnetic member 15 or by the sealing member connected to the first magnetic member 15 causing the liquid outlet hole 132 to be in communication with the liquid storage chamber 121. At the time, the tobacco liquid in the liquid storage chamber 121 flows into the liquid outlet mechanism 13 via the liquid guiding hole 131, and then the tobacco liquid flows into the atomizing chamber 221 via the liquid outlet hole 132. The direction by the arrow in FIG. 4 indicates the flowing direction of the tobacco liquid.

In the illustrated embodiment, the north poles N of the first magnetic member 15 and the second magnetic member 24 face each other. It can be understood that, in alternative embodiment not shown, the south poles S of the first magnetic member 15 and the second magnetic member 24 face each other. It can also be understood that, the first magnetic member 15 and the second magnetic member 24 can also be electromagnets, a repulsive action between the first magnetic member 15 and the second magnetic member 24 is established by a control of the spiral orientation of the coil or the current flowing through the coil.

Referring to FIG. 5 again, when the cigarette cartridge 101 is separated from the atomizing assembly 102, the first magnetic member 15 is moved back to an original position due to an elastic action of the elastic member 14, finally enabling the first magnetic member 15 to seal the liquid guiding hole 131, the liquid storage chamber 121 is isolated from the liquid outlet hole 132 again. When the cigarette cartridge 101 is stored separately, a leakage of the tobacco liquid and an accident swallowing of the tobacco liquid by children can be avoided

The structure of the battery pack 30 of the electronic cigarette 200 provided by the second embodiment is same as that of the battery pack 30 in the first embodiment, which is not specifically described again.

### The Third Embodiment

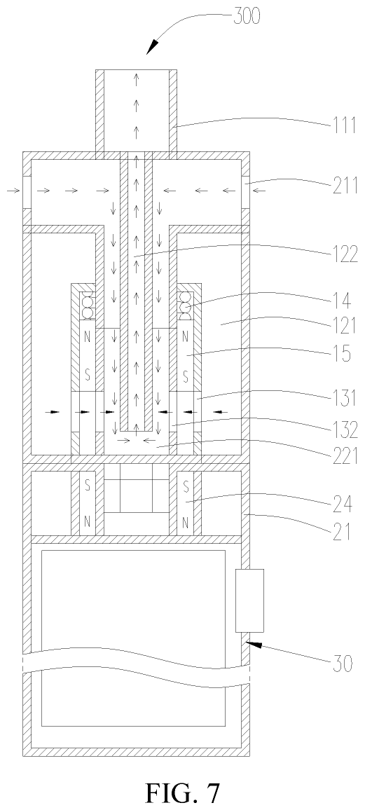

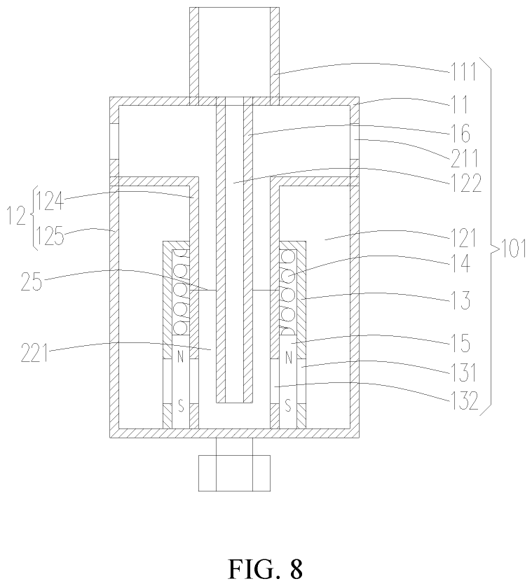

Referring to FIG. 7 and FIG. 8, the main difference between the electronic cigarette 300 provided by the third embodiment and the electronic cigarette 100 provided by the first embodiment is that: the air intake types and the liquid intake types are different, in the first embodiment, the air enters from the lower end, the liquid enters from the upper end, in the third embodiment, the air enters from the upper end, the liquid enters from the sidewall.

Specifically, referring to FIG. 8, the cigarette cartridge 101 includes a housing 11, a liquid storage member 12 positioned in the housing 11, a liquid outlet mechanism 13 received in the liquid storage member 12, an elastic member 14, a first magnetic member 15, and an air exhaust tube 16 connected to the housing 11. The elastic member 14 and the first magnetic member 15 are received in the liquid outlet mechanism 13.

The liquid storage member 12 substantially has a columnar structure. The liquid storage member 12 includes an internal sleeve 124 and an external sleeve 125 sleeved on the internal sleeve 124. A cavity between the internal sleeve 124 and the external sleeve 125 forms a liquid storage chamber 121, the liquid outlet mechanism 13 is fixedly received in the liquid storage chamber 121, and the liquid outlet mechanism 13 is sleeved on the internal sleeve 124. The liquid guiding hole 131 is defined on the sidewall of the liquid outlet mechanism 13, the liquid outlet hole 132 is defined on the internal sleeve 124 and corresponds to the liquid guiding hole 131, and the liquid guiding hole 131 is in communication with the liquid outlet hole 132. The elastic member 14 and the first magnetic member 15 are received in a cavity formed by the internal sleeve 124 and the liquid outlet mechanism 13. An end of the elastic member 14 elastically resists the liquid outlet mechanism 13, an opposite end of the elastic member 14 elastically resists the first magnetic member 15, the first magnetic member 15 is slidably received in the liquid outlet mechanism 13. When the cigarette cartridge 101 is stored separately, due to an elastic action of the elastic member 14, the first magnetic member 15 is fixedly pressed, the first magnetic member 15 seals the liquid guiding hole 131. At the time the liquid storage chamber 121 is closed and is isolated from the liquid outlet hole 132, thus the tobacco liquid in the liquid storage chamber 121 cannot flow in the liquid outlet mechanism via the liquid guiding hole 131.

Referring to FIG. 7 and FIG. 8, the atomizing assembly 102 of the illustrated embodiment includes a connecting seat 21, an atomizing head 25, and a second magnetic member 24.

Referring to FIG. 8, the atomizing head 25 is fixedly positioned in the internal sleeve 124, the atomizing head 25 defines an atomizing chamber 221 therein, the atomizing head 25 defines a permeable hole (not shown) corresponding to the liquid outlet hole 132 and in communication with the atomizing chamber 221. Referring to FIG. 7, the second magnetic member 24 is fixedly positioned in the connecting seat 21. When the connecting seat 21 is assembled to the cigarette cartridge 101, because the second magnetic member 24 and the first magnetic member 15 are mutually repulsive, and the repulsive force between the second magnetic member 24 and the first magnetic member 15 is greater than the elastic force of the first elastic member 14, thus the first magnetic member 15 compresses the elastic member 14 and moves, the first magnetic member 15 finally opens the liquid guiding hole 131, the liquid storage chamber 121 is in communication with the liquid outlet hole 132. At the time, the tobacco liquid in the liquid storage chamber 121 flows into the liquid outlet mechanism 13 via the liquid guiding hole 131, and then the tobacco liquid passes through the liquid outlet hole 132 and the permeable hole successively. Then, the tobacco liquid flows into the atomizing head 25, and is heated and atomized by the heating structure (not shown) in the atomizing head 25 to form aerosol. The indicated direction by the bold arrow in FIG. 7 is the flowing direction of the tobacco liquid.

In the illustrated embodiment, the south poles S of the first magnetic member 15 and the second magnetic member 24 face each other. It can be understood that, in alternative embodiment not shown, the north poles N of the first magnetic member 15 and the second magnetic member 24 face each other. It can also be understood that, the first magnetic member 15 and the second magnetic member 24 can also be electromagnets, a repulsive action between the first magnetic member 15 and the second magnetic member 24 is established by a control of the spiral orientation of the coil or the current flowing through the coil.

Referring to FIG. 8, the housing 11 has a structure same as that in the first embodiment, wherein is not specifically described hereby. An end of the air exhaust tube 16 is connected to the housing 11 and corresponds to the mouth piece connector 111, an opposite end of the air exhaust tube 16 is plugged into the atomizing head 25, the interior space in the air exhaust tube 16 forms an air exhaust passage 122, the air exhaust passage 122 is in communication with the mouth piece connector 111 and the atomizing chamber 221 at the same time.

Referring to FIG. 7, the internal wall of the housing 11 tightly contacts the external annular surface of the liquid storage member 12, the external wall of the housing 11 defines a first air intake hole 211 above the liquid storage member 12 and in communication with the atomizing chamber 221. When user inhales, the external air flows into the atomizing chamber 221 via the first air intake hole 211, the air is mixed with the aerosol and then flows into user's mouth by passing through the air exhaust passage 122 and the mouth piece connector 111 successively. The indicated direction by the fine arrow in FIG. 7 is the flow direction of the air flow.

It can be understood that, the part of the internal sleeve 124 clamped between the atomizing head 25 and the liquid outlet mechanism 13 can be omitted. At the time, a side of the first magnetic member 15 contacts the internal wall of the liquid outlet mechanism 13 to close the liquid guiding hole 131. A side of the first magnetic member 15 away from the liquid outlet mechanism 13 contacts the sidewall of the atomizing head 25 to close the permeable hole. When the cigarette cartridge 101 is connected to the atomizing assembly 102, the first magnetic member 15 is moved upward to open the liquid guiding hole 131 and the permeable hole. The tobacco liquid flows into the interior of the atomizing head 25 by passing through the liquid guiding hole 131 and the permeable hole, and is atomized to form aerosol.

In the battery pack 30 of the electronic cigarette 300 of the third embodiment, the first air intake hole 211 of the battery housing 31 is omitted, the other structures of the battery pack 30 are same as that in the first embodiment, which is not specifically described hereby.

The embodiments described above are merely preferred embodiments, but not intended to limit the application. Any modifications, alternatives or improvements made within the principle and spirit of the present application should be interpreted as falling within the protection scope of the present application. The claims are not limited to the features or acts described above. Rather, the proper scope of the disclosure is defined by the appended claims.

What is claimed is:

1. A cigarette cartridge, comprising:
a liquid storage member defining a liquid storage chamber;
an elastic member and a first magnet member both received in the liquid shortage member or positioned outside the liquid storage member;
wherein the cigarette cartridge defines a liquid guiding hole in communication with the liquid storage chamber; an end of the elastic member is fixedly relative to the liquid storage member, an opposite end of the elastic member elastically resists the first magnetic member, the first magnetic member is capable of moving under an elastic action of the elastic member, causing the liquid guiding hole to be closed.

2. The cigarette cartridge according to claim 1, wherein the first magnetic member is slidable along an axial direction or along a radial direction of the liquid storage member.

3. The cigarette cartridge according to claim 1, further comprising a sealing member fixedly connected to the first magnetic member, when the first magnetic member moves under an elastic force of the elastic member, the sealing member closes the liquid guiding hole.

4. The cigarette cartridge according to claim 1, further comprising a liquid outlet mechanism, wherein the liquid guiding hole is positioned on the liquid outlet mechanism, the cigarette cartridge further defines a liquid outlet hole in communication with the liquid guiding hole, the first magnetic member is slidably accommodated within the liquid outlet mechanism, an end of the elastic member elastically resists an internal wall of the liquid outlet mechanism, an opposite end of the elastic member elastically resists the first magnetic member, the first magnetic member is capable of closing the liquid guiding hole under an action of the elastic member.

5. The cigarette cartridge according to claim 4, wherein the liquid guiding hole is defined on a sidewall of the liquid outlet mechanism, the liquid outlet hole is defined on a lower end of the liquid outlet mechanism.

6. The cigarette cartridge according to claim 4, wherein the liquid storage member comprises an internal sleeve and an external sleeve sleeved on the internal sleeve, the liquid storage chamber is formed by a cavity between the external sleeve and the internal sleeve, the liquid outlet mechanism is received in the liquid storage chamber and is sleeved on the internal sleeve, both the elastic member and the first magnetic member are positioned in a cavity between the internal sleeve and the liquid outlet mechanism.

7. The cigarette cartridge according to claim 6, wherein the liquid outlet hole is defined on the internal sleeve, the liquid guiding hole is defined on a sidewall of the liquid outlet mechanism and corresponds to the liquid outlet hole.

8. The cigarette cartridge according to claim 7, wherein the elastic member is retractable along an axial direction of the liquid storage member, an end of the elastic member resists a top of the liquid outlet mechanism, an opposite end of the elastic member resists the first magnetic member, the external wall of the first magnetic member tightly contacts the internal wall of the liquid outlet mechanism, thereby closing the liquid guiding hole of the liquid outlet mechanism.

9. An atomizer, comprising a cigarette cartridge and an atomizing assembly connected to the cigarette cartridge,
the cigarette cartridge comprising:
a liquid storage member defining a liquid storage chamber;
an elastic member and a first magnet member both received in the liquid shortage member or positioned outside the liquid storage member;
wherein the cigarette cartridge defines a liquid guiding hole in communication with the liquid storage chamber; an end of the elastic member is fixedly relative to the liquid storage member, an opposite end of the elastic member elastically resists the first magnetic member, the first magnetic member is capable of moving under an elastic action of the elastic member, causing the liquid guiding hole to be closed, the atomizing assembly comprises a second magnetic member, the second magnetic member and the first magnetic member are mutually repulsive, when the atomizing assembly is assembled to the cigarette cartridge, a repulsive force between the second magnetic member and the first magnetic member is greater than an elastic force of the elastic member, so that, during operation, the first magnetic member compresses and moves the elastic member to open the liquid guiding hole.

10. The atomizer according to claim 9, wherein the atomizing assembly comprises an atomizing end cover connected to the cigarette cartridge, an interior space of the atomizing end cover forms an atomizing chamber, the atomizing end cover defines a liquid intake hole in communication with the atomizing chamber, the second magnetic member is fixedly accommodated in the atomizing chamber.

11. The atomizer according to claim 10, wherein the atomizing assembly comprises a connecting seat and an atomizing head, the connecting seat is connected to the cigarette cartridge, the atomizing head is fixedly positioned in the internal sleeve, the atomizing head defines an atomizing chamber and a permeable hole in communication with the atomizing chamber, the second magnetic member is fixedly received in the connecting seat.

12. The atomizer according to claim 11, wherein a sidewall of the connecting seat defines a first air intake hole, an upper end surface of the connecting seat defines a second air intake hole in communication with the first air intake hole.

13. The atomizer according to claim 12, further comprising a heating structure received in the atomizing end cover, wherein the heating structure is fixedly positioned in the atomizing chamber.

14. The atomizer according to claim 9, wherein both the first magnetic member and the second magnetic member are electromagnets.

15. An electronic cigarette, comprising an atomizer;
the atomizer comprising a cigarette cartridge and an atomizing assembly connected to the cigarette cartridge;
the cigarette cartridge comprising:
a liquid storage member defining a liquid storage chamber;
an elastic member and a first magnet member both received in the liquid shortage member or positioned outside the liquid storage member;
wherein the cigarette cartridge defines a liquid guiding hole in communication with the liquid storage chamber; an end of the elastic member is fixedly relative to the liquid storage member, an opposite end of the elastic member elastically resists the first magnetic member, the first magnetic member is capable of moving under an elastic action of the elastic member, causing the liquid guiding hole to be closed, the atomizing assembly comprises a second magnetic member, the second magnetic member and the first magnetic member are mutually repulsive, when the atomizing assembly is assembled to the cigarette cartridge, a repulsive force between the second magnetic member and the first magnetic member is greater than an elastic force of the elastic member, so that, during operation, the first magnetic member compresses and moves the elastic member to open the liquid guiding hole.

16. The electronic cigarette according to claim 15, comprising a battery pack connected to the atomizer, wherein the battery pack comprises a battery housing, a battery and a power source switch, the battery is fixedly received in the battery housing, the battery is electrically connected to the heating member, the power source switch is positioned on the battery housing, and the power source switch is electrically connected to the battery.

17. The electronic cigarette according to claim 16, wherein the liquid storage member is made of transparent materials of translucent materials.

18. The electronic cigarette according to claim 17, wherein the cigarette cartridge comprising a housing and the liquid storage member received in the housing, the housing defines an opening at a lower end, an upper end of the housing forms a mouth piece connector in communication with an interior chamber of the housing and extending upward along an axial direction of the housing, an exhaust passage is positioned between the liquid storage member and the housing, the exhaust passage is in communication with the mouth piece connector.
